(19) United States
(12) Patent Application Publication
(10) Pub. No.: US 2011/0136939 A1
(43) Pub. Date: Jun. 9, 2011

(54) TIRE WITH COMPONENT CONTAINING CELLULOSE

(76) Inventors: Annette Lechtenboehmer, Ettelbruck (LU); David Andrew Benko, Munroe Falls, OH (US); Maurice Peter Klinkenberg, Vichten (LU); Joseph John Kulig, Tallmadge, OH (US); Klaus Unseld, Luxembourg (LU); Georges Marcel Victor Thielen, Schouweiler (LU); Claude Ernest Felix Boes, Erpeldange (LU); Hans-Bernd Fuchs, Konz (DE)

(21) Appl. No.: 12/632,910

(22) Filed: Dec. 8, 2009

(51) Int. Cl. C08J 3/22; C08L 1/00

(52) U.S. Cl. 523/351; 524/35

(57) ABSTRACT

The present invention is directed to a method of making a rubber composition, comprising the steps of mixing cellulose fibers and water to form a first mixture; mixing the first mixture with an aqueous diene-based elastomer latex to form a second mixture comprising cellulose fibers, elastomer, and water; and separating the cellulose fibers and elastomer from the water to form a elastomer/cellulose masterbatch.

### BACKGROUND OF THE INVENTION

In an effort to include renewable resources as components in tires, naturally occurring organic materials have previously been used as fillers in tire rubber compositions. However, compatibility between the organic fillers and rubber is generally poor, leading to low filler loading due to poor filler dispersion and poor adhesion between the rubber and the filler. There is therefore a need for improved rubber compositions containing naturally occurring organic fillers.

### SUMMARY OF THE INVENTION

The present invention is directed to a method of making a rubber composition, comprising the steps of mixing cellulose fibers and water to form a first mixture; mixing the first mixture with an aqueous diene-based elastomer latex to form a second mixture comprising cellulose fibers, elastomer, and water; and separating the cellulose fibers and elastomer from the water to form a elastomer/cellulose masterbatch.

### BRIEF DESCRIPTION OF THE DRAWINGS

FIG. 1 is a graph of tensile properties for several rubber samples.

FIG. 2 is a graph of stress-strain properties for several rubber samples.

FIG. 3 is a graph of tan delta versus strain for several rubber samples.

### DETAILED DESCRIPTION OF THE INVENTION

There is disclosed a method of making a rubber composition, comprising the steps of mixing cellulose fibers and water to form a first mixture; mixing the first mixture with an aqueous diene-based elastomer latex to form a second mixture comprising cellulose fibers, elastomer, and water; and separating the cellulose fibers and elastomer from the water to form a elastomer/cellulose masterbatch.

In a first step, cellulose fibers and water are mixed to form a first mixture. In one embodiment, cellulose fibers may be added as an aqueous paste with a relatively high solids content of fiber. In one embodiment, the cellulose fibers may be added as an aqueous paste with from 5 to 50 percent by weight of cellulose fibers. The cellulose fibers are mixed with sufficient water to obtain a mixture of cellulose in water that may be mixed with an elastomer latex.

In a second step, the first mixture of cellulose fibers and water is mixed with a diene-based elastomer latex to form a second mixture. The amount of latex combined with the first mixture of cellulose fibers and water is such as to result in the desired ratio of elastomer to cellulose in the final masterbatch. Suitable diene-based elastomer latex includes natural rubber latex, polyisoprene latex, styrene-butadiene rubber latex, polybutadiene rubber latex, nitrile rubber latex, and the like.

In a third step, water is separated from the second mixture containing the cellulose fiber, elastomer, and water to obtain the final masterbatch of cellulose fibers and elastomer. Separation may be done using any of the various techniques as are known in the art, including but not limited to filtration, centrifugation, and drying.

The elastomer/cellulose masterbatch is used in a rubber composition. In one embodiment, the rubber composition includes elastomer and cellulose from the masterbatch, and other additives as are described as follows.

The rubber composition thus includes a cellulose fiber. By cellulose fiber, it is meant that the cellulose therein is substantially free of lignin. As described herein, the term “cellulose fiber” is intended to exclude those cellulosic materials containing substantial amounts of lignin, such as wood fiber. In one embodiment, the cellulose fiber is from 95 to 99.5 percent cellulose.

In one embodiment, the cellulose fiber has an average length of from 15 to 25 microns. In one embodiment, the cellulose fiber has an average length of from 15 to 20 microns. In one embodiment, the cellulose fiber has an average thickness of from 10 to 20 microns. In one embodiment, the cellulose fiber has an average thickness of from 12 to 18 microns.

In one embodiment, the cellulose fiber is a cellulose having a diameter ranging from 1 to 4000 nanometers. In one embodiment, the cellulose fiber is a cellulose having a diameter ranging from 1 to 1000 nanometers. In one embodiment, the cellulose fiber is a cellulose having a diameter ranging from 5 to 500 nanometers.

Suitable cellulose fiber is available commercially from J. Rettenmaier & Sohne GmbH as Arbocel® Arbocel Nano Disperse Cellulose MH 40-10 (10 percent by weight solids) or MH 40-40 (40 percent by weigh solids).

In one embodiment, from 1 to 10 phr of an additive effective in coupling the cellulose to rubber may be added during the mixing of the first mixture. In one embodiment, from 1 to 10 phr of 3,3′-dithiopropionic acid is added during the mixing of the first mixture.

In one embodiment, the cellulose fiber is present in the rubber composition in a concentration ranging from 1 to 30 parts by weight per 100 parts by weight of diene based elastomer (phr). In another embodiment, the cellulose fiber is present in the rubber composition in a concentration ranging from 5 to 25 parts by weight per 100 parts by weight of diene based elastomer (phr). In another embodiment, the cellulose fiber is present in the rubber composition in a concentration ranging from 10 to 20 parts by weight per 100 parts by weight of diene based elastomer (phr).

The rubber composition may be used with rubbers or elastomers containing olefinic unsaturation. The phrases “rubber or elastomer containing olefinic unsaturation” or “diene based elastomer” are intended to include both natural rubber and its various raw and reclaim forms as well as various synthetic rubbers. In the description of this invention, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials and such terms are well known to those having skill in the rubber mixing or rubber compounding art. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. The preferred rubber or elastomers are polyisoprene (natural or synthetic), polybutadiene and SBR.

In one aspect the rubber is preferably of at least two of diene based rubbers. For example, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, cis 1,4-polybutadiene rubbers and emulsion polymerization prepared butadiene/acrylonitrile copolymers.

In one aspect of this invention, an emulsion polymerization derived styrene/butadiene (E-SBR) might be used having a relatively conventional styrene content of about 20 to about 28 percent bound styrene or, for some applications, an E-SBR having a medium to relatively high bound styrene content, namely, a bound styrene content of about 30 to about 45 percent.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

In one embodiment, cis 1,4-polybutadiene rubber (BR) may be used. Such BR can be prepared, for example, by organic solution polymerization of 1,3-butadiene. The BR may be conveniently characterized, for example, by having at least a 90 percent cis 1,4-content.

The cis 1,4-polyisoprene and cis 1,4-polyisoprene natural rubber are well known to those having skill in the rubber art.

The term “phr” as used herein, and according to conventional practice, refers to “parts by weight of a respective material per 100 parts by weight of rubber, or elastomer.”

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as MES, TDAE, SRAE and heavy naphthenic oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

The rubber composition may include from about 10 to about 150 phr of silica. In another embodiment, from 20 to 80 phr of silica may be used.

The commonly employed siliceous pigments which may be used in the rubber compound include conventional pyrogenic and precipitated siliceous pigments (silica). In one embodiment, precipitated silica is used. The conventional siliceous pigments employed in this invention are precipitated silicas such as, for example, those obtained by the acidification of a soluble silicate, e.g., sodium silicate.

Such conventional silicas might be characterized, for example, by having a BET surface area, as measured using nitrogen gas. In one embodiment, the BET surface area may be in the range of about 40 to about 600 square meters per gram. In another embodiment, the BET surface area may be in a range of about 80 to about 300 square meters per gram. The BET method of measuring surface area is described in the Journal of the American Chemical Society, Volume 60, Page 304 (1930).

The conventional silica may also be characterized by having a dibutylphthalate (DBP) absorption value in a range of about 100 to about 400, alternatively about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc.

Commonly employed carbon blacks can be used as a conventional filler in an amount ranging from 10 to 150 phr. In another embodiment, from 20 to 80 phr of carbon black may be used. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

Other fillers may be used in the rubber composition including, but not limited to, particulate fillers including ultra high molecular weight polyethylene (UHMWPE), crosslinked particulate polymer gels including but not limited to those disclosed in U.S. Pat. Nos. 6,242,534; 6,207,757; 6,133,364; 6,372,857; 5,395,891; or 6,127,488, and plasticized starch composite filler including but not limited to that disclosed in U.S. Pat. No. 5,672,639. Such other fillers may be used in an amount ranging from 1 to 30 phr.

In one embodiment the rubber composition may contain a conventional sulfur containing organosilicon compound. Examples of suitable sulfur containing organosilicon compounds are of the formula:

Z-Alk-Sₙ-Alk-Z I

in which Z is selected from the group consisting of

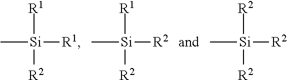

where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

In one embodiment, the sulfur containing organosilicon compounds are the 3,3′-bis(trimethoxy or triethoxy silylpropyl)polysulfides. In one embodiment, the sulfur containing organosilicon compounds are 3,3′-bis(triethoxysilylpropyl)disulfide and/or 3,3′-bis(triethoxysilylpropyl)tetrasulfide. Therefore, as to formula I, Z may be

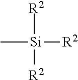

where R² is an alkoxy of 2 to 4 carbon atoms, alternatively 2 carbon atoms; alk is a divalent hydrocarbon of 2 to 4 carbon atoms, alternatively with 3 carbon atoms; and n is an integer of from 2 to 5, alternatively 2 or 4.

In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials.

In another embodiment, suitable sulfur containing organosilicon compounds include those disclosed in U.S. Patent Publication No. 2003/0130535. In one embodiment, the sulfur containing organosilicon compound is Si-363 from Degussa.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The rubber composition may be incorporated in a variety of rubber components of the tire. For example, the rubber component may be a tread (including tread cap and tread base), sidewall, apex, chafer, sidewall insert, wirecoat or innerliner. In one embodiment, the component is a tread.

The pneumatic tire of the present invention may be a race tire, passenger tire, aircraft tire, agricultural, earthmover, off-the-road, truck tire, and the like. In one embodiment, the tire is a passenger or truck tire. The tire may also be a radial or bias.

Vulcanization of the pneumatic tire of the present invention is generally carried out at conventional temperatures ranging from about 100° C. to 200° C. In one embodiment, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The invention is further illustrated by the following nonlimiting examples.

### Example 1

In this example, the method of combining a 10 percent by weight aqueous dispersion cellulose fiber with an elastomer latex to prepare a 15 phr cellulose in elastomer mixture is illustrated. In a first step, 400 g of a cellulose paste (Arbocel Nano Disperse Cellulose MH 40-10, from J. Rettenmaier & Sohne) containing 10 percent by weight of solids was diluted with 400 g of water. The mixture was stirred for 30 minutes, with a final pH of 5.2. In a separate mix step, 430 g of high ammonia natural rubber latex containing 61.9 percent by weight of solids at pH 10.3 was diluted with 430 g of water and 5 g of a 50 percent by weight hindered phenol antioxidant (Bostex 24). The latex mixture was stirred for 25 minutes. Subsequently, the latex mixture was transferred to a container with a 36 g water rinse, followed by addition of the cellulose mixture over 1 minute with a 123 g water rinse, with continuous agitation. The combined latex and cellulose dispersion was stirred for 15 minutes.

The latex cellulose dispersion was dried via application of 50 to 100 g lots of the dispersion to a hot mill (drum dryer) at 141° C. Solid rubber/cellulose samples of approximately 30 g were collected at the knife edges. Each sample was dried by passing through the mill 5 times. A total of 289 g was collected (theoretical yield 307 g, 95 percent recovery). Final moisture content was 0.57 percent with a Mooney viscosity MS (1+4) of 60.3 and Tg of −62.2° C. The samples were stabilized with 0.5 phr of Bostex 24. This product is referred to as Sample 1.

### Example 2

The procedure of Example 1 was repeated, except for use of 400 g of 40 percent by weight aqueous dispersion cellulose fiber (Arbocel Nano Disperse Cellulose MH 40-40, from J. Rettenmaier & Sohne) instead of the 10 percent by weight material. All other amounts doubled to yield 578 g of 15 phr cellulose in elastomer with a final moisture content of 0.43 percent, a Mooney MS (1+4) of 75.1 and Tg of −62.1° C. This product is referred to as Sample 2.

### Example 3

The procedure of Example 2 was repeated, except for addition of 1 phr of 3,3′-dithiopropionic acid. The yield was 567 g of 15 phr cellulose and 1 phr 3,3′-dithiopropionic acid in elastomer with a final moisture content of 1.31 percent, a Mooney MS (1+4) of 70.6 and Tg of −62.1° C. This product is referred to as Sample 3.

### Example 4

In this example, the effect of combining the samples of Examples 1, 2 and 3 in rubber compounds is illustrated. Nine rubber compounds were prepared following the recipe in Table 1, with all amount shown in phr. Rubber compounds were mixed using a two-step mix procedure with one non-productive mix step and one productive mix step in a Brabender Plasticorder and cured to 10 min at 150° C., near t₉₀. Sample 4 was a control with no added cellulose. Samples 9 and 10 were comparative, containing a cellulose having a larger diameter. Samples 5 through 8 and 11 and 12 contained the samples of Examples 1, 2 or 3 and are representative of the present invention.

The samples were tested for viscoelastic properties using RPA. “RPA” refers to a Rubber Process Analyzer as RPA 2000™ instrument by Alpha Technologies, formerly the Flexsys Company and formerly the Monsanto Company. References to an RPA 2000 instrument may be found in the following publications: H. A. Palowski, et al, Rubber World, June 1992 and January 1997, as well as Rubber & Plastics News, Apr. 26 and May 10, 1993.

The “RPA” test results in Table 2 are reported as being from data obtained at 100° C. in a dynamic shear mode at a frequency of 1 hertz and at the reported dynamic strain values. Tensile properties were also measured and reported in Table 2.

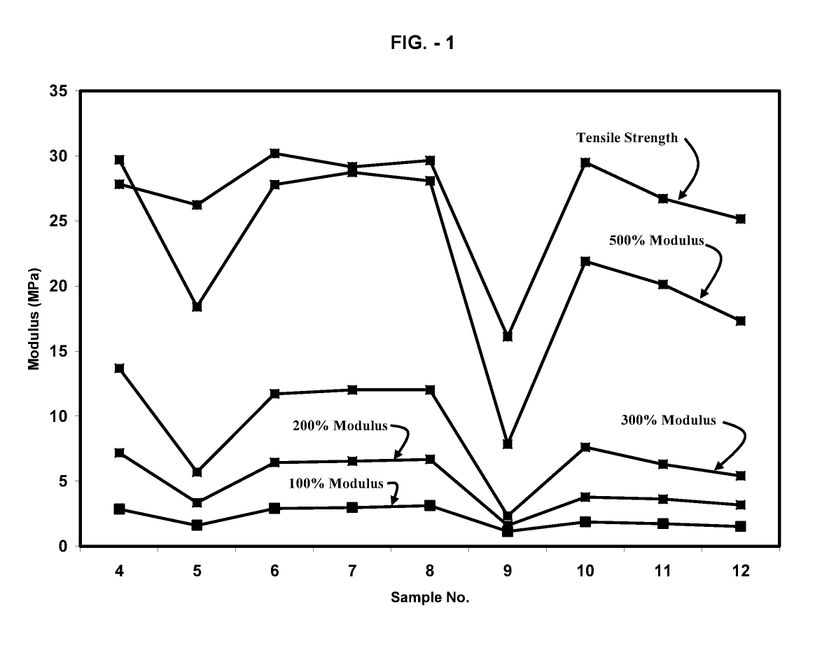

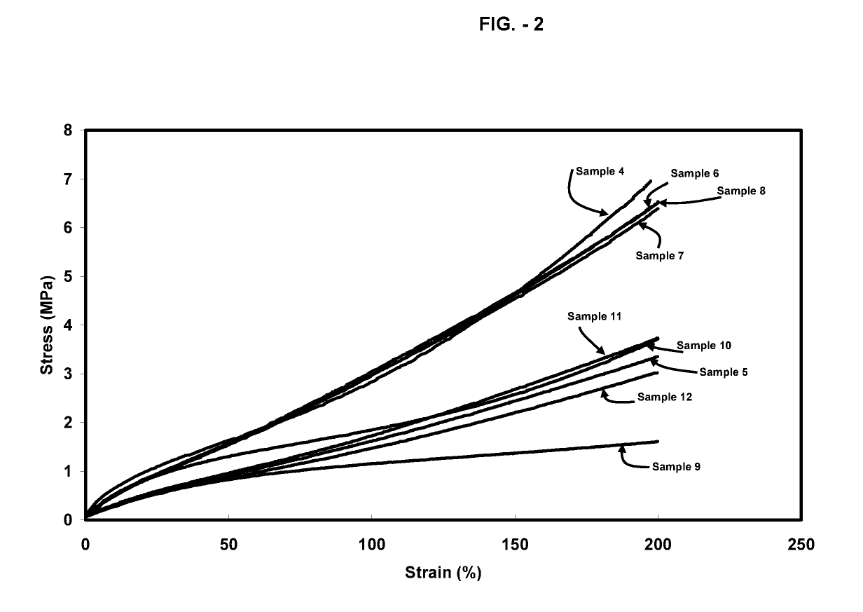

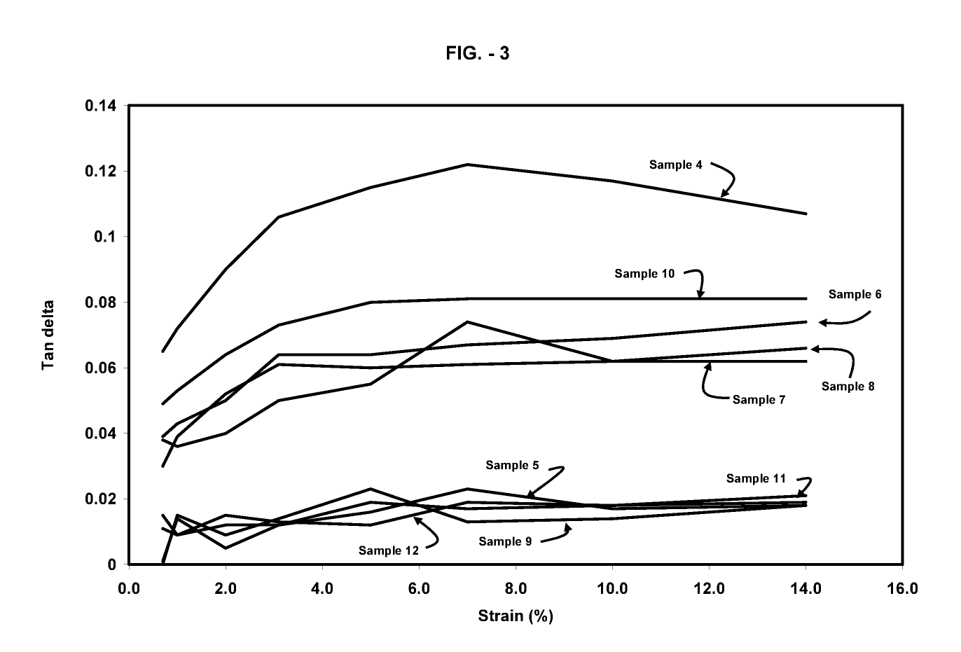

A graph of tensile properties is given in FIG. 1. A graph of stress-strain properties for samples 4 through 12 is given in FIG. 2. A graph of tan delta versus strain for samples 4 through 12 is given in FIG. 3.

TABLE 1

| | Sample No. | | | | | | | | |
|---|---|---|---|---|---|---|---|---|---|
| | 4 | 5 | 6 | 7 | 8 | 9 | 10 | 11 | 12 |
| Type | cont | inv | inv | inv | inv | comp | comp | inv | inv |
| Non-Productive Mix Step | | | | | | | | | |
| Natural Rubber | 100 | 0 | 0 | 0 | 0 | 100 | 100 | 0 | 0 |
| Sample 1¹ | 0 | 115 | 115 | 0 | 0 | 0 | 0 | 0 | 0 |
| Sample 2² | 0 | 0 | 0 | 115 | 0 | 0 | 0 | 115 | 0 |
| Sample 3³ | 0 | 0 | 0 | 0 | 115 | 0 | 0 | 0 | 115 |
| Carbon Black | 45 | 0 | 30 | 30 | 30 | 0 | 30 | 0 | 0 |
| Cellulose⁴ | 0 | 0 | 0 | 0 | 0 | 15 | 15 | 0 | 0 |
| Antidegradant⁵ | 1 | 1 | 1 | 1 | 1 | 1 | 1 | 1 | 1 |
| Zinc Oxide | 5 | 5 | 5 | 5 | 5 | 5 | 5 | 5 | 5 |
| Stearic Acid | 2 | 2 | 2 | 2 | 2 | 2 | 2 | 2 | 2 |
| Productive Mix Step | | | | | | | | | |
| Sulfur | 2 | 2 | 2 | 2 | 2 | 2 | 2 | 2 | 2 |
| Accelerator⁶ | 1.1 | 1.1 | 1.1 | 1.1 | 1.1 | 1.1 | 1.1 | 1.1 | 1.1 |

¹Product of Example 1, 15 phr cellulose in natural rubber
²Product of Example 2, 15 phr cellulose in natural rubber
³Product of Example 3, 15 phr cellulose with 1 phr of 3,3′ dithiopropionic acid in natural rubber
⁴Arbocel 600-10 TG, from J. Rettenmaier & Sohne
⁵Para-phenylene diamine type
⁶Sulfenamide type

TABLE 2

| Sample No. | | | | | | | | |
|---|---|---|---|---|---|---|---|---|
| 4 | 5 | 6 | 7 | 8 | 9 | 10 | 11 | 12 |

RPA2000
Test: @ 100° C., Frequency = 11 Hz, Strain Sweep = 0.7/1.0/2.0/3.1/5.0/7.0/10.0/14.0

| | | | | | | | | | |
|---|---|---|---|---|---|---|---|---|---|
| G′, 1% strain, MPa | 3.06 | 0.67 | 1.41 | 1.38 | 1.5 | 0.66 | 1.7 | 0.67 | 0.71 |
| G′, 5% strain, MPa | 2.21 | 0.66 | 1.25 | 1.23 | 1.35 | 0.65 | 1.41 | 0.65 | 0.7 |
| G′, 10% strain, MPa | 1.89 | 0.66 | 1.14 | 1.14 | 1.23 | 0.65 | 1.27 | 0.65 | 0.7 |
| Tanδ, 10% strain | 0.117 | 0.017 | 0.069 | 0.062 | 0.062 | 0.014 | 0.081 | 0.018 | 0.018 |

Cold Tensile D53504
Cure: Best @ 150° C.; Test: @ 23° C., Pulling Speed = 20 Cm/Min

| | | | | | | | | | |
|---|---|---|---|---|---|---|---|---|---|
| Elong. At Break, % | 499 | 577 | 532 | 523 | 510 | 607 | 580 | 554 | 590 |
| 100% Mod., Mpa | 2.9 | 1.6 | 2.9 | 3.0 | 3.1 | 1.1 | 1.9 | 1.7 | 1.5 |
| 300% Mod., MPa | 13.7 | 5.7 | 11.7 | 12.0 | 12.0 | 2.3 | 7.6 | 6.3 | 5.4 |
| Tens. Strength, MPa | 29.4 | 26.0 | 30.4 | 30.5 | 28.8 | 15.6 | 28.7 | 25.6 | 25.7 |

As seen in FIG. 1, modulus values show the reinforcing properties of the cellulose compounds prepared according to the present invention: the non-black compounds with cellulose (Samples 5 and 11) have a higher modulus and tensile strength than the one with the “coarse” cellulose (Sample 9). The same is true to a lesser extent for the combinations of cellulose with carbon black (Samples 6, 7 and 8 versus Sample 10).

This behavior is confirmed by the stress strain curves as shown in FIG. 1; note the differences between Samples 5 and 11 versus Sample 9, and between 6, 7 and 8 versus Sample 10. Samples 6 and 7 containing 15 phr cellulose and 30 phr black matched the stress-strain behavior of the full black compound Sample 4 with 45 phr black. By contrast, Sample 10 with 15 phr “coarse” cellulose and 30 phr black could not had much inferior stress-strain behavior compared to control Sample 4.

Hysteresis, as indicated by tangent delta measure using RPA at 100° C., is lower for the carbon black/cellulose combinations than for the carbon black/“coarse” cellulose combination.

The data overall indicate that the use of cellulose in rubber shows strong reinforcing effects, an increase in modulus and tensile, a positive effect on hysteresis, compared to “coarse” cellulose.

While certain representative embodiments and details have been shown for the purpose of illustrating the invention, it will be apparent to those skilled in this art that various changes and modifications may be made therein without departing from the spirit or scope of the invention.

What is claimed is:

1. A method of making a rubber composition, comprising the steps of
mixing cellulose fibers and water to form a first mixture;
mixing the first mixture with an aqueous diene-based elastomer latex to form a second mixture comprising cellulose fibers, elastomer, and water; and
separating the cellulose fibers and elastomer from the water to form a elastomer/cellulose masterbatch.

2. The method of claim 1, wherein the cellulose fibers have an average diameter of 1 to 4000 nm.

3. The method of claim 1, wherein the cellulose fibers have an average diameter of 1 to 1000 nm.

4. The method of claim 1, wherein the cellulose fibers have an average diameter of 5 to 500 nm.

5. The method of claim 1, further comprising addition of from 1 to 10 phr of 3,3′ dithiopropionic acid to the first mixture.

6. The method of claim 1, wherein the cellulose fiber is present in the elastomer/cellulose masterbatch in a concentration ranging from 5 to 25 parts by weight per 100 parts by weight of diene based elastomer (phr).

7. The method of claim 1, wherein the cellulose fiber has an average length of from 15 to 25 microns.

8. The method of claim 1, wherein the cellulose fiber has an average length of from 15 to 20 microns.

9. The pneumatic tire of claim 1, wherein the diene based elastomer is selected from the group consisting of natural rubber, synthetic polyisoprene rubber, polybutadiene rubber, and styrene-butadiene rubber.

10. A rubber composition comprising the cellulose/elastomer masterbatch made by the method of claim 1.

11. A pneumatic tire comprising the rubber composition of claim 10.

12. The rubber composition of claim 10, wherein the rubber composition further comprises from 20 to 80 phr of carbon black.

13. The rubber composition of claim 10, wherein the rubber composition further comprises from 20 to 80 phr of silica.
